(19) United States
(12) Patent Application Publication
(10) Pub. No.: US 2018/0044064 A1
(43) Pub. Date: Feb. 15, 2018

(54) COCONUT TAP

(71) Applicants: Anthony Bruce Clarke, Attadale (AU); Tracey Leann Clarke, Attadale (AU)

(72) Inventors: Anthony Bruce CLARKE, Attadale (AU); Ashley WELKE, Bibra Lake (AU); Edward Joseph KHOURY, Bateman (AU)

(21) Appl. No.: 15/557,083

(22) PCT Filed: Mar. 8, 2016
(86) PCT No.: PCT/AU2016/050163

§ 371 Date: Sep. 9, 2017

(30) Foreign Application Priority Data
Mar. 9, 2015 (AU) 2015900832

(51) Int. Cl. B65D 25/48; B26F 1/32; A23N 5/03

(52) U.S. Cl. CPC B65D 25/48; A23N 5/03; B26F 1/32

(57) ABSTRACT

A coconut tap (10) comprising a tubular body (12) having first and second ends (14, 16) and a tapered portion adjacent the first end (14). A pin (22) is received in the body (12) such that a pointed first end thereof protrudes through an opening (18) in the first end (14) of the body (12). One or more apertures (28) are provided in the body (12) adjacent the first end (14) such that the first end (14) of may be inserted through the inner shell (13) of a coconut (11) at the site of an eye (15) such that the apertures (28) are located inside the inner shell (13) to allow water from within the coconut (11) to enter the body (12) and exit via the open second end (16).

### FIELD OF THE INVENTION

The present invention relates to a device for draining coconut water from a coconut.

### BACKGROUND TO THE INVENTION

The sale of young coconuts for the coconut water contained within is a growing industry. Such coconuts are generally sold intact with some of the outer layers removed. In a common form of processing, the outer part of the coconut is cut such that there is provided a flat base and a conical top.

A common problem however is that opening the coconut to gain access to the water within is difficult. The inner shell of the coconut must be penetrated and this inner shell is relatively hard. Many methods are proposed for achieving this result, generally comprising cutting or striking the coconut with a knife or other tool.

The present invention relates to a device and method provided for tapping a coconut to allow the water to either be drained or consumed directly from the shell.

### SUMMARY OF THE INVENTION

According to one aspect of the present invention there is provided a coconut tap comprising:

a tubular body having a tapered portion adjacent a first end;
a pin received an open second end of the body such that a pointed first end of the pin protrudes through an opening in the first end of the body;
one or more apertures in a side wall of the body adjacent the first end thereof;
wherein the first end of the body may be inserted through the inner shell of a coconut at the site of an eye of the coconut such that the apertures are located inside the inner shell of the coconut such that water from within the coconut may enter the body and exit the body via the open second end.

Preferably the pin comprises an elongate shaft including a head adjacent the second end thereof such that the head engages with the second end of the body.

In a preferred embodiment, the body comprises a tube being circular in transverse cross section.

Preferably the tapered portion tapers inwardly such that the diameter of the tube remains constant or decreases from the second end to the first end.

In a preferred embodiment, the tube tapers inwardly from the second end to the first end.

Preferably the shaft of the pin includes an inwardly taper corresponding with the taper of the tube.

Preferably the pointed first end of the shaft of the pin protruding beyond the opening in the tube includes a solid outer surface.

Preferably the shaft includes a solid outer surface such that the outer surface of the shaft engages against an inner surface of the tube along the length thereof and blocks the apertures in the tube.

In a preferred embodiment, the shaft comprises an unbroken frustoconical outer wall.

Preferably the body is provided also with ribs on the outer surface thereof.

The ribs preferably comprise elongate planar protrusions extending longitudinally along the body from the second end to a location between the second end and the first end.

Preferably the ribs extend from the second end of the tube to a location adjacent the apertures such that ends thereof engage with the inner shell when the apertures are located inside the inner shell.

In a preferred embodiment, the head of the pin include protrusions on an underside located adjacent the ends of the ribs.

In one embodiment, the body is provided with a pair of apertures adjacent the first end.

Preferably the apertures comprise elongate apertures aligned along the length of the body.

In one embodiment, the pin is provided with an applicator connected to the second end thereof.

Preferably the applicator comprises a T-shaped handle having a shaft connected to the second end of the pin and a handle portion extending transversely to the shaft at an end remote from the pin.

In accordance with a second aspect of the present invention, there is provided a coconut tap comprising:

a tubular body having first and second ends, the body having a tapered portion adjacent the first end;
one or more apertures in a side wall of the body adjacent the first end thereof;
wherein the first end of the body may be inserted through the shell of a coconut at the site of an eye of the coconut such that the apertures are located inside the inner shell of the coconut such that water from within the coconut may enter the body via the apertures and exit the body via the open second end.

In one embodiment, the body has a closed first end comprising the nose portion of the coconut tap.

In one embodiment, an outer surface of the body is provided with a helical thread and the first end of the body is provided with a pair of handles extending outwardly from the body on opposite sides thereof such that the body may be rotated to draw the body through the coconut.

In one embodiment, the body is movable from a tubular configuration to a flattened configuration for packaging.

In one embodiment, the body includes a plurality of grooves extending from the second end to the first end such that the body may bend about the grooves to be collapsed from the tubular configuration to the flattened configuration.

The body may be provided with an air channel comprising a conduit extending from the second end of the body to a location adjacent the apertures to allow air to be drawn into the interior of the coconut as the water flows outwardly through the body.

In accordance with a third aspect of the present invention, there is provided a method of tapping a coconut comprising the steps:

locating an eye of the coconut;
inserting a tapered first end of a tubular body through an inner shell of the coconut at the position of the eye; and
draining water from within the coconut.

### BRIEF DESCRIPTION OF THE DRAWINGS

The invention will now be described, by way of example, with reference to the following drawings, in which:

FIG. 1a is a front view of a coconut tap in accordance with the present invention;

FIG. 1b is a side view of the coconut tap of FIG. 1a;

FIG. 2 is an exploded view of the coconut tap of FIG. 1;

FIG. 3a is a cross sectional view of the pin of the coconut tap of FIG. 1;

FIG. 3b is a front view of the pin of the coconut tap of FIG. 1;

FIG. 3c is a cross sectional view of the body of the coconut tap of FIG. 1;

FIG. 3d is a front view of the body of the coconut tap of FIG. 1;

FIG. 4a is a front view of the coconut tap of FIG. 1 prior to insertion into a coconut;

FIG. 4b is an upper perspective view of the coconut tap of FIG. 1 prior to insertion into the coconut;

FIG. 5a is a side view of the coconut tap of FIG. 1 prior to insertion into the coconut;

FIG. 5b is a cross sectional view of the coconut tap of FIG. 1 prior to insertion into the coconut;

FIG. 6a is a front view of the coconut tap of FIG. 1 inserted into the coconut;

FIG. 6b is an upper perspective view of the coconut tap of FIG. 1 inserted into the coconut;

FIG. 7a is a side view of the coconut tap of FIG. 1 inserted into the coconut;

FIG. 7b is a cross sectional view of the coconut tap of FIG. 1 inserted into the coconut;

FIG. 8a is a front view of the coconut tap of FIG. 1 showing removal of the pin;

FIG. 8b is an upper perspective view of the coconut tap of FIG. 1 showing removal of the pin;

FIG. 9a is a side view of the coconut tap of FIG. 1 showing removal of the pin;

FIG. 9b is a cross sectional view of the coconut tap of FIG. 1 showing removal of the pin;

FIG. 10a is a front view of the coconut tap of FIG. 1 showing use of a straw for accessing the coconut water;

FIG. 10b is an upper perspective view of the coconut tap of FIG. 1 showing use of the straw for accessing the coconut water;

FIG. 11 is an upper perspective view of a second embodiment of a coconut tap in accordance with the present invention;

FIG. 12a is a front view of the coconut tap of FIG. 11;

FIG. 12b is a first side view of the coconut tap of FIG. 11;

FIG. 12b is a top view of the coconut tap of FIG. 11;

FIG. 12d is a rear view of the coconut tap of FIG. 11;

FIG. 12e is a bottom view of the coconut tap of FIG. 11;

FIG. 12f is a second side view of the coconut tap of FIG. 11;

FIG. 13a is a front view of the coconut tap of FIG. 11 inserted into the coconut;

FIG. 13b is an upper perspective view of the coconut tap of FIG. 11 inserted into the coconut;

FIG. 14a is a side view of the coconut tap of FIG. 11 inserted into the coconut;

FIG. 14b is a cross sectional view of the coconut tap of FIG. 11 inserted into the coconut;

FIG. 15 is an upper perspective view of a third embodiment of a coconut tap in accordance with the present invention;

FIG. 16a is a front view of the coconut tap of FIG. 15;

FIG. 16b is a first side view of the coconut tap of FIG. 15;

FIG. 16c is a top view of the coconut tap of FIG. 15;

FIG. 16d is a rear view of the coconut tap of FIG. 15;

FIG. 16e is a bottom view of the coconut tap of FIG. 15;

FIG. 16 is a second side view of the coconut tap of FIG. 15;

FIG. 17a is a front view of the coconut tap of FIG. 15 inserted into the coconut;

FIG. 17b is an upper perspective view of the coconut tap of FIG. 15 inserted into the coconut;

FIG. 18a is a side view of the coconut tap of FIG. 15 inserted into the coconut;

FIG. 18b is a cross sectional view of the coconut tap of FIG. 15 inserted into the coconut;

FIG. 19 is an upper perspective view of a fourth embodiment of a coconut tap in accordance with the present invention;

FIG. 20a is a first side view of the coconut tap of FIG. 19;

FIG. 20b is a top view of the coconut tap of FIG. 19;

FIG. 20c is a front view of the coconut tap of FIG. 19;

FIG. 20d is a bottom view of the coconut tap of FIG. 19;

FIG. 20d is a second side view of the coconut tap of FIG. 19;

FIG. 21 is an upper perspective view of the coconut tap of FIG. 19 in a flattened configuration;

FIG. 22a is a front view of the coconut tap of FIG. 19 inserted into the coconut;

FIG. 22b is an upper perspective view of the coconut tap of FIG. 19 inserted into the coconut;

FIG. 23a is a side view of the coconut tap of FIG. 19 inserted into the coconut;

FIG. 23b is a cross sectional view of the coconut tap of FIG. 19 inserted into the coconut;

FIG. 24a is a front view of a fifth embodiment of a coconut tap in accordance with the present invention prior to insertion into the coconut;

FIG. 24b is a front view of the coconut tap of FIG. 24a inserted into the coconut; and

FIG. 25 is a front view of the coconut tap of FIG. 24 with the pin and handle removed.

### DETAILED DESCRIPTION OF PREFERRED EMBODIMENTS

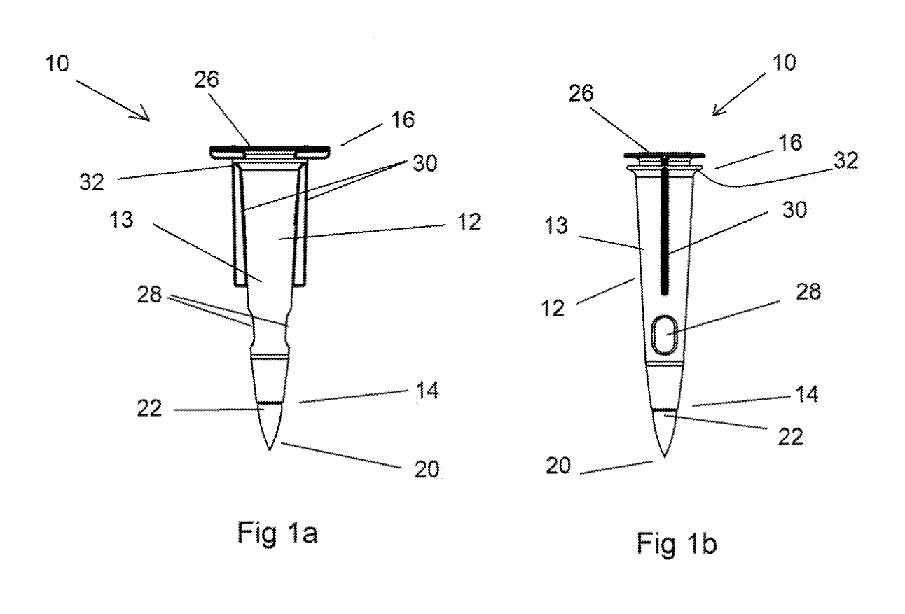

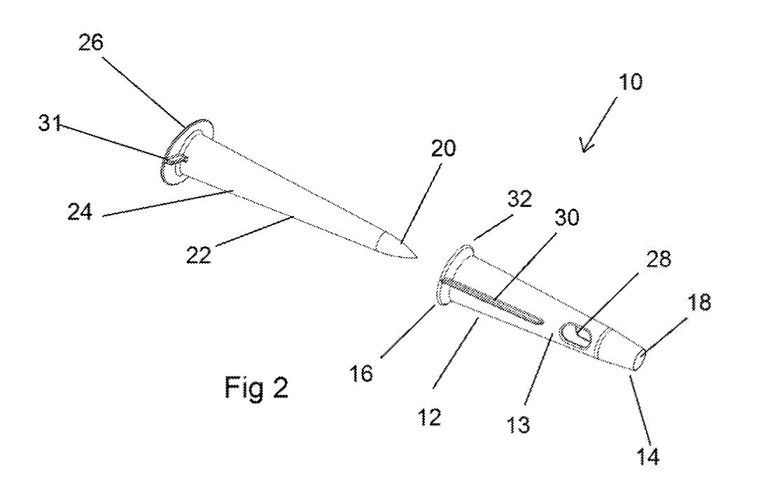

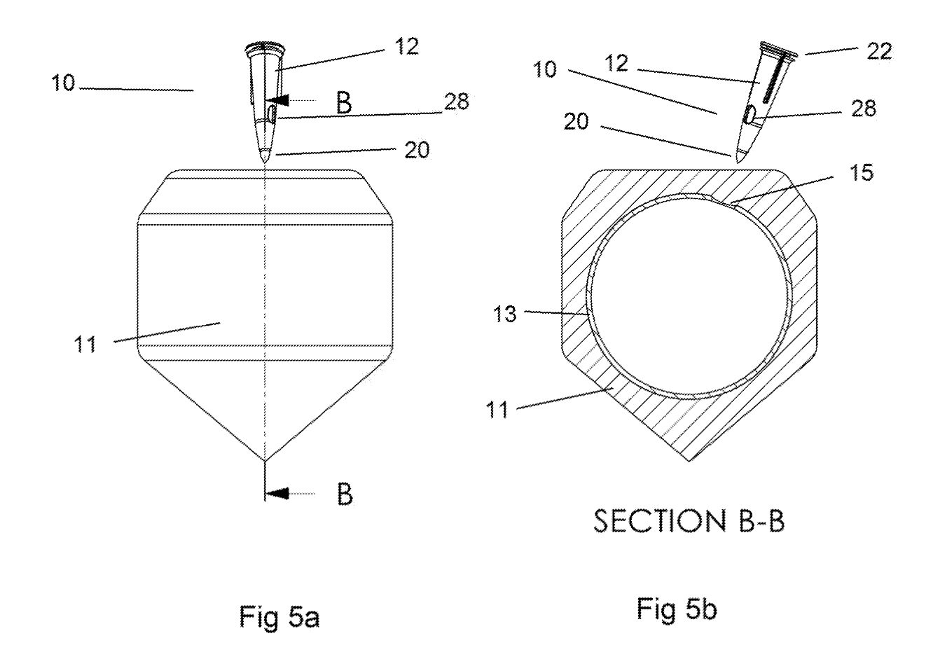

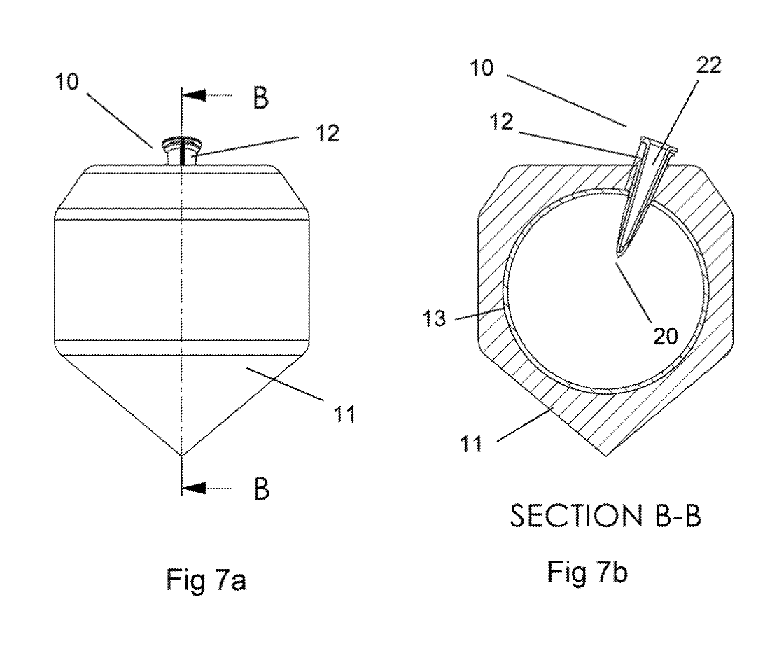

Referring to FIGS. 1 to 10, there is shown a coconut tap 10 comprising a body 12 having a first end 14 and a second end 16. The body 12 comprises a tube 13 such that the body 12 is generally hollow. In the embodiment shown, the tube 13 is circular in transverse cross section.

The body 12 includes a tapered portion adjacent the first end 14 thereof. The tapered portion tapers smoothly inwardly towards the first end 14 of the body 12 from a location offset from the first end 14 such that the diameter of the tube 13 remains constant or decreases from the second end 16 to the first end 14. In the embodiment shown, the tube 13 tapers inwardly from the second end 16 to the first end 14.

The coconut tap 10 is provided with a nose portion 20 at the first end 14 thereof. The nose portion 20 comprises a pointed first end of the coconut tap 10 such that the nose portion 20 may be used to pierce the inner shell 13 of a coconut 11 to provide access to the water within.

In the embodiment of FIGS. 1 to 10, the coconut tap 10 is formed from the tubular body 12 and a central pin 22. The pin 22 comprises an elongate shaft 24 having pointed first end and a head 26 at a second end thereof.

The pin 22 is receivable within the body 12 such that the first end thereof protrudes through an opening 18 provided in the first end 14 of the body 12. The pointed first end of the pin 22 protrudes beyond the body 12 and forms the nose portion 20 of the coconut tap 10. The head 26 of the pin 22 engages with the second end 16 of the body 12 to prevent further movement of the pin 22 through the body 12.

The body 12 includes also one or more apertures 28 therein. The apertures 28 are provided in the body 12 adjacent the first end 14 thereof such that when the body 12 is inserted through the inner shell 13 of the coconut 11, the apertures 28 are located on an inner side of the inner shell 13. In the embodiment shown, the body 12 is provided with a pair of such apertures 28 on opposite sides of the body 12. The apertures 28 comprise elongate apertures aligned along the length of the body 12.

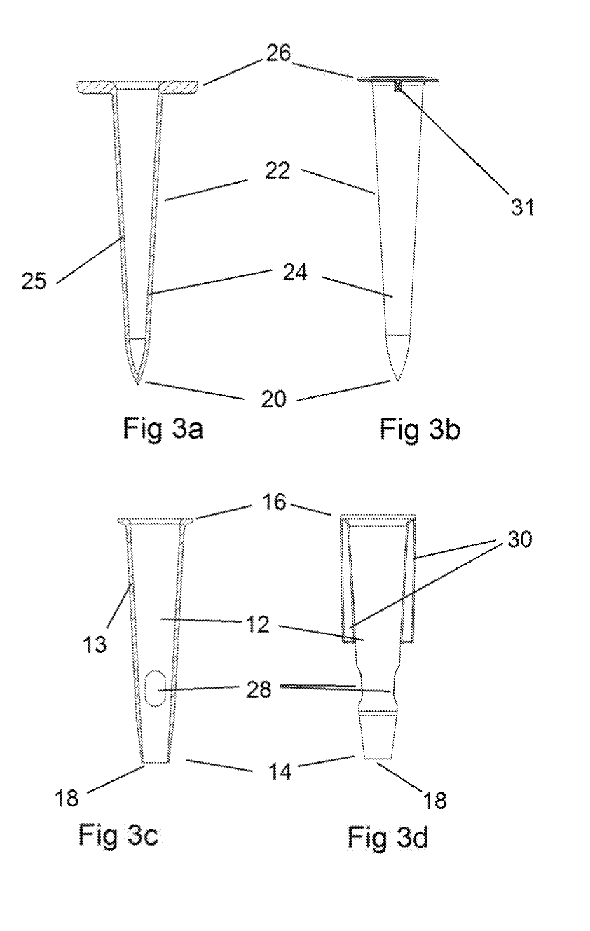

The shaft 24 of the pin 22 includes an inwardly taper corresponding with the taper of the tube 13. The shaft 24 of the pin 22 therefore tapers inwardly from the second end to the first end in the embodiment shown. The pointed first end protruding beyond the opening 18 in the tube 13 includes a solid outer surface as shown in the Figures. The shaft 24 includes a solid outer surface such that the outer surface of the shaft 24 engages against an inner surface of the tube 13 along the length thereof. In the embodiment shown, the shaft 24 comprises an unbroken frustoconical outer wall 25 (as can be seen in FIG. 3a). The outer surface of the shaft 24 of the pin 22 therefor engages against the inner surface of the tube 13 to provide rigidity to the tube 13 as the coconut tap 10 is pressed into the coconut 11. The outer surface 24 of the shaft 22 blocks the apertures 28 when received within the tube 13 and the solid nose portion 20 provides strength to pierce the coconut 11.

The body 12 is provided also with ribs 30 on the outer surface thereof. The ribs 30 comprise elongate planar protrusions extending longitudinally along the body 12 from the second end 16 to a location between the second end 16 and the first end 14. The ribs 30 provide additional strength and engage with the inner shell 13 to locate the tubular body 12 relative to the inner shell 13. In the embodiment shown, there is provided a pair of ribs 30 on opposite sides of the outer surface of the tube 13.

The ribs 30 extend from the second end 16 of the tube 13 to a location adjacent the apertures 28. Ends of the ribs 30 adjacent the apertures 28 are located to engage with the inner shell 13 of the coconut in use to correctly locate the apertures 28.

The second end of the body 12 is provided also with a lip portion 32. The lip portion 32 extends outwardly from around the periphery of the body 12 around the second end 16 such that the head 26 of the pin 22 engages against the lip portion 32 when the pin 22 is received within the body 12.

The head 26 of the pin 22 include also protrusions 31 on an underside thereof adjacent the lip portion 32. The protrusions 31 are provided to engage with the lip portion 32 adjacent the ends of the ribs 30. The protrusions 31 provide strength to the head 26 and aid in transferring force through to the ribs 30 of the tube 13.

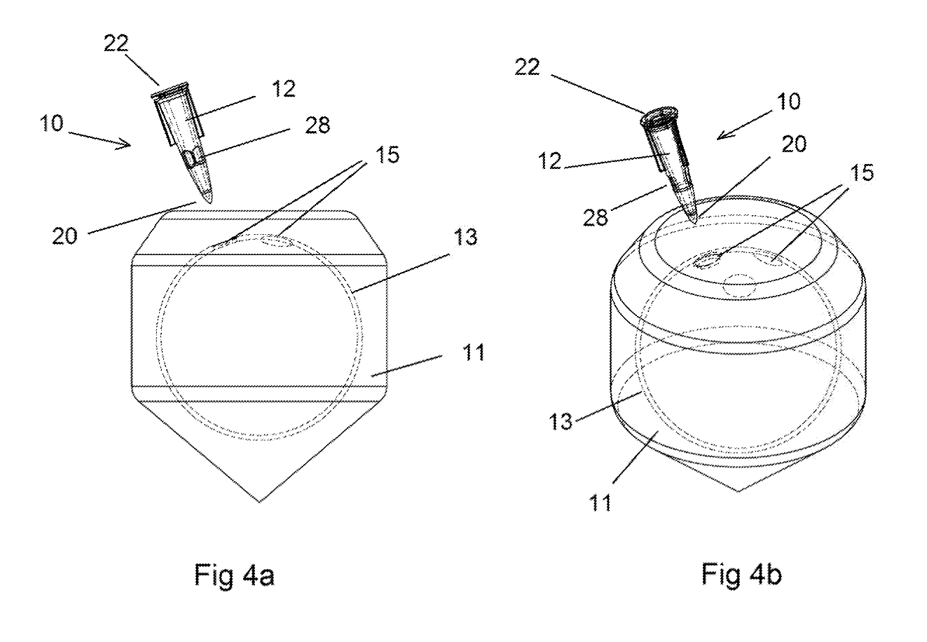

In use, the coconut tap 10 is used as shown in FIGS. 4 to 10. The coconut tap 10 is to be inserted by pushing the nose portion 20 through the outer layers of the coconut 11 and through the inner shell 13. The coconut tap 10 is to be inserted through one of the eyes 15 of the coconut 11. Coconuts generally include three such eyes 15, located on the base side of the coconut 11. It has been discovered that by locating the correct position on the coconut, the coconut tap 10 of the present invention may be simply pushed through the eye 15 by hand without the need for further tools.

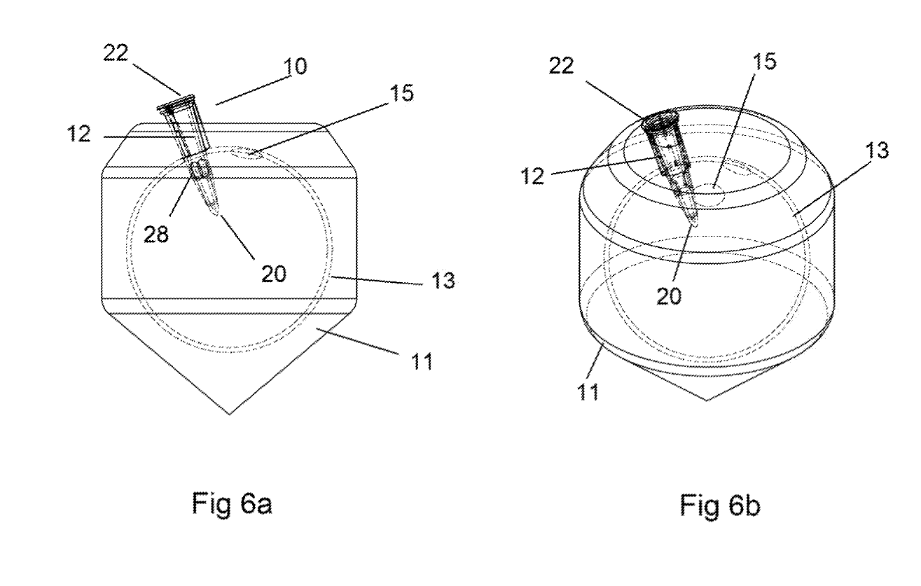

The ends of the ribs 30 are spaced from the apertures 28 such that the ends thereof engage with the inner shell 13 (as can be seen in FIG. 6a) when the apertures 28 are located inside the inner shell 13.

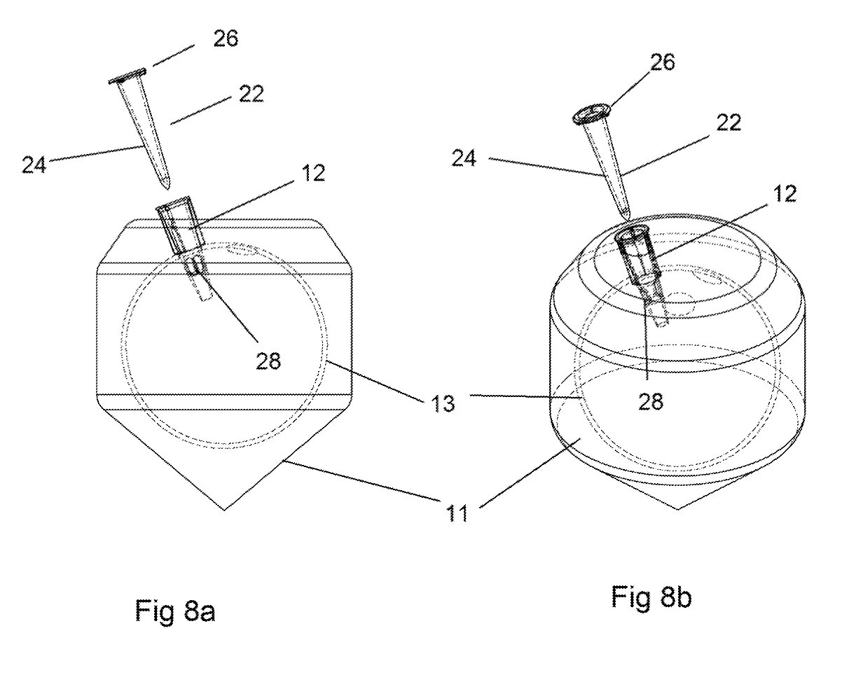

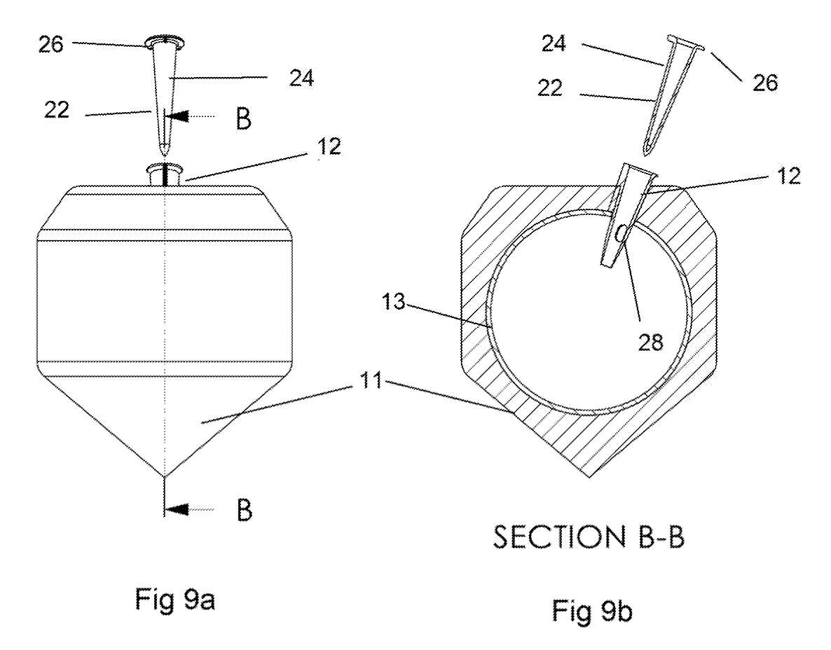

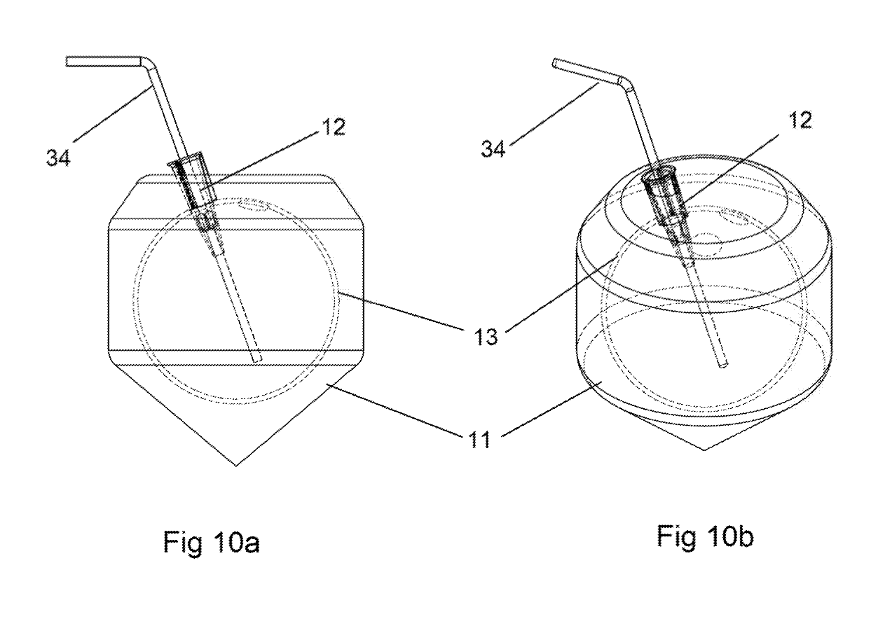

Once the coconut tap 10 has passed through the inner shell 13 of the coconut 11, the pin 22 may be removed (as shown in FIGS. 8 and 9). The water from within the coconut 11 may then be drained through the body 12 by tipping the coconut 11. The water will pass into the body 12 through the apertures 28 and the opening 18 and out of the open second end 16. The opening 18 left at the first end 14 of the body 12 by removal of the pin 22 will also allow a straw 34 to be inserted through the body 12 (as shown in FIG. 10) so that the water may alternatively be consumed directly from the coconut 11.

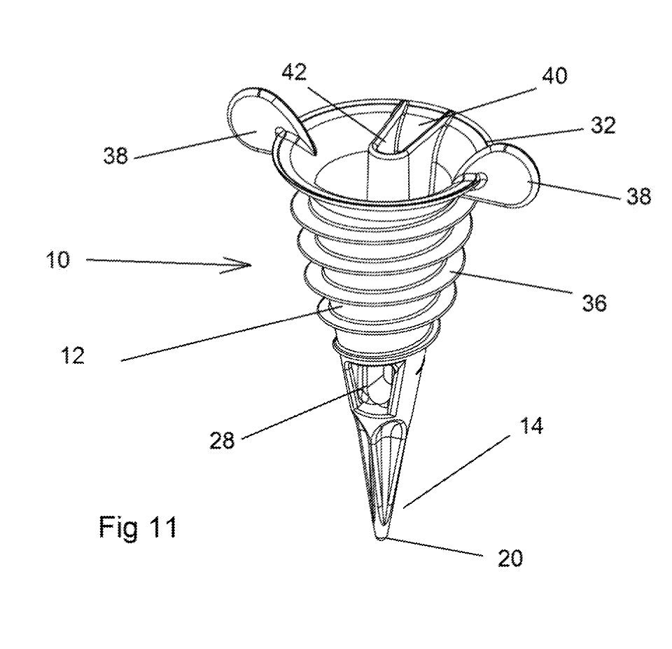

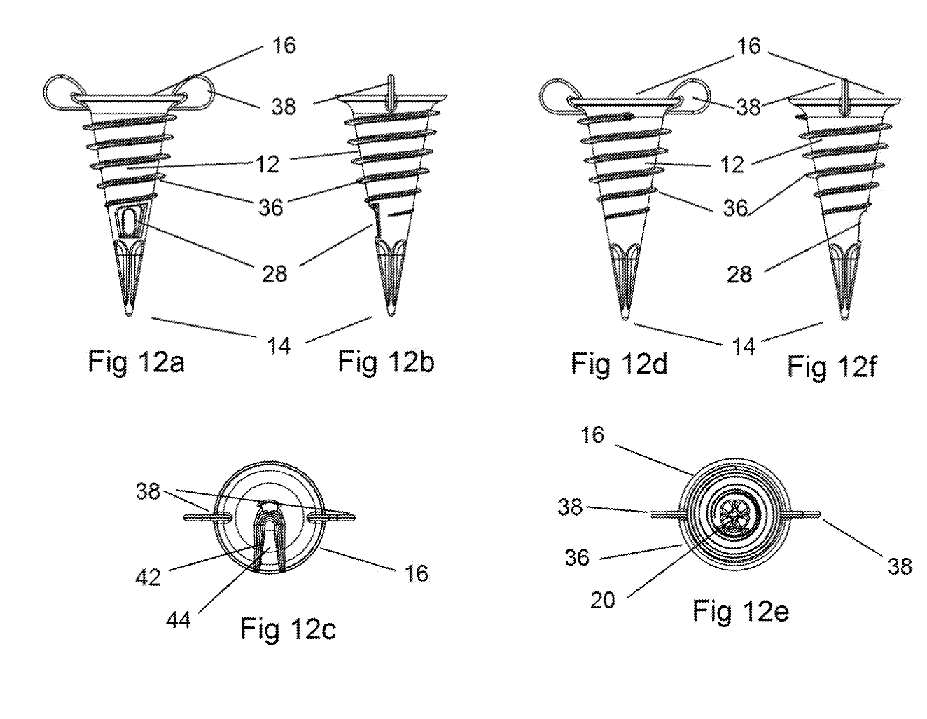

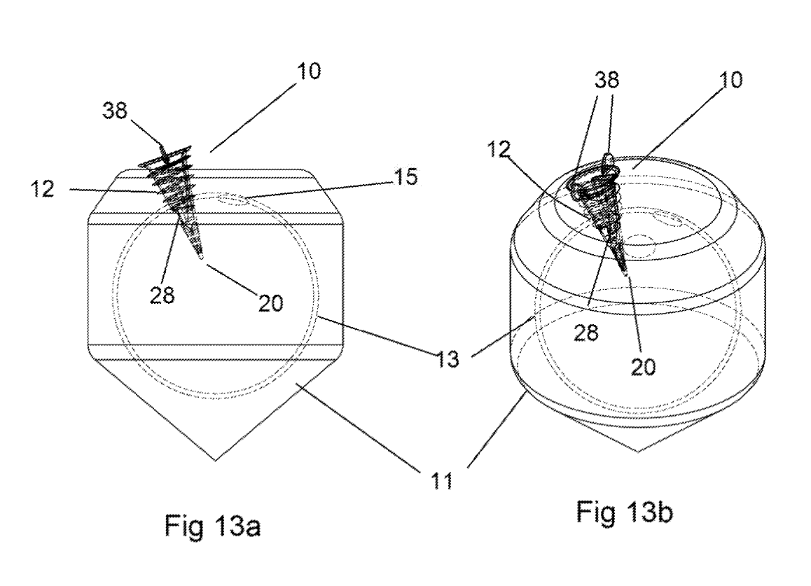

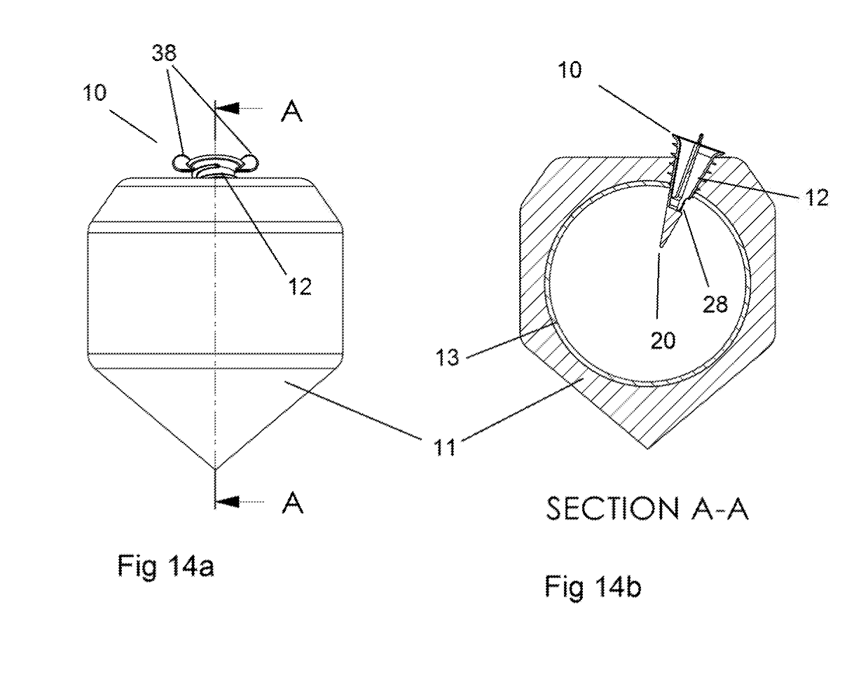

FIGS. 11 to 14 show a second embodiment of a coconut tap 10. The coconut tap 10 of FIGS. 11 to 14 is similar to the first embodiment and like reference numerals are used to denote like parts.

The coconut tap 10 comprises a body 12 having a closed first end 14 and does not therefore utilise the separate pin 22. The closed first end 14 therefore includes the nose portion 20. An outer surface of the body 12 is provided with a helical thread 36 and the first end 16 of the body 12 is provided with a pair of handles 38 extending outwardly on opposite sides thereof.

The body 12 may therefore be inserted through the inner shell 13 of the coconut 11 in a similar manner to that described previously, however the body 12 is rotated through the inner shell 13 by the handles 38. The helical thread 36 acts to draw the body 12 through the outer layer and inner shell 13 of the coconut 11.

The body 12 is provided also with an air channel 40. The air channel 40 comprises a conduit 42 extending down an inner surface of the body 12, as best seen in FIG. 11. The conduit 42 extends from the second end 16 of body to a location adjacent the apertures 28 and is provided to allow air to be drawn into the interior of the coconut 11 as the water flows outwardly through the body 12. It will be appreciated that the first embodiment may also be provided with such an air channel 40.

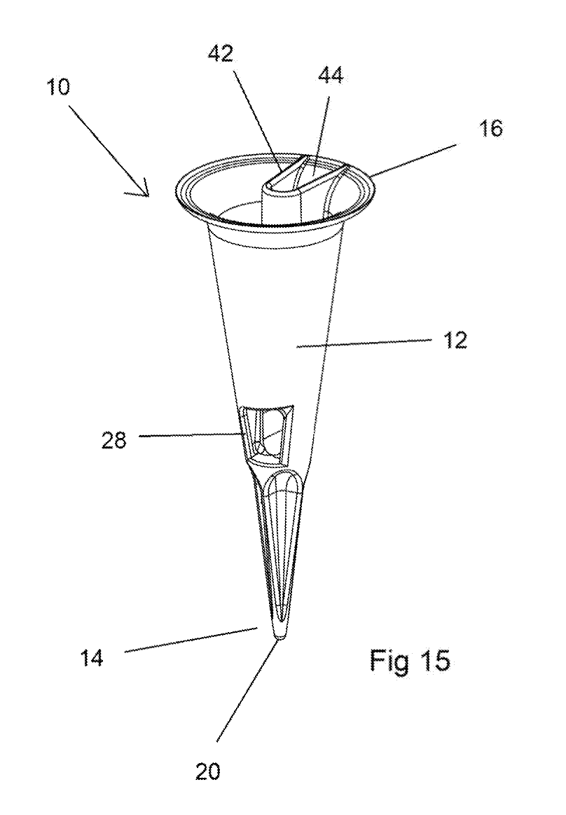

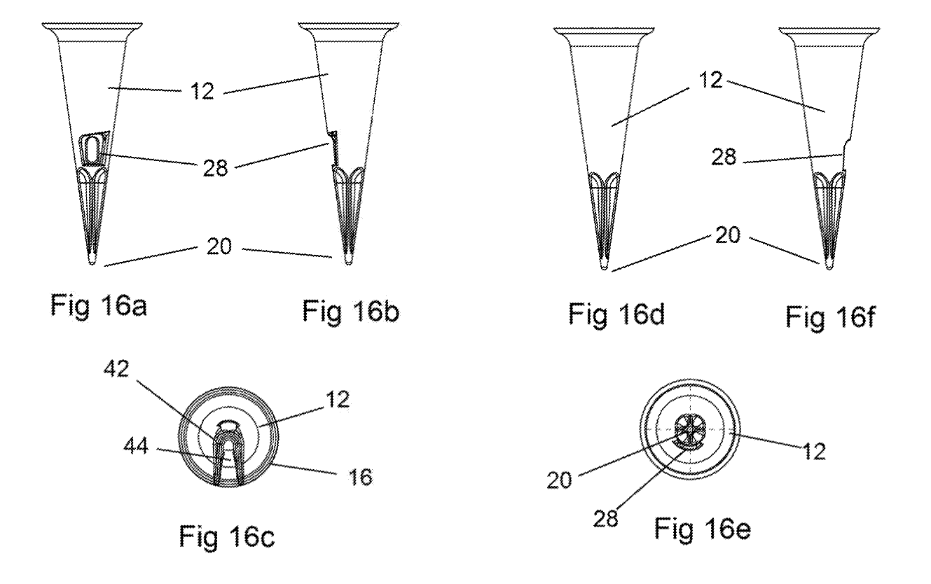

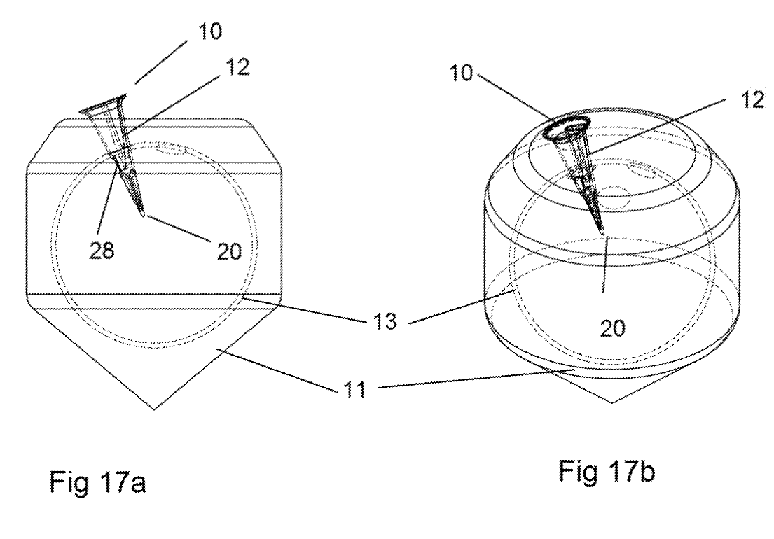

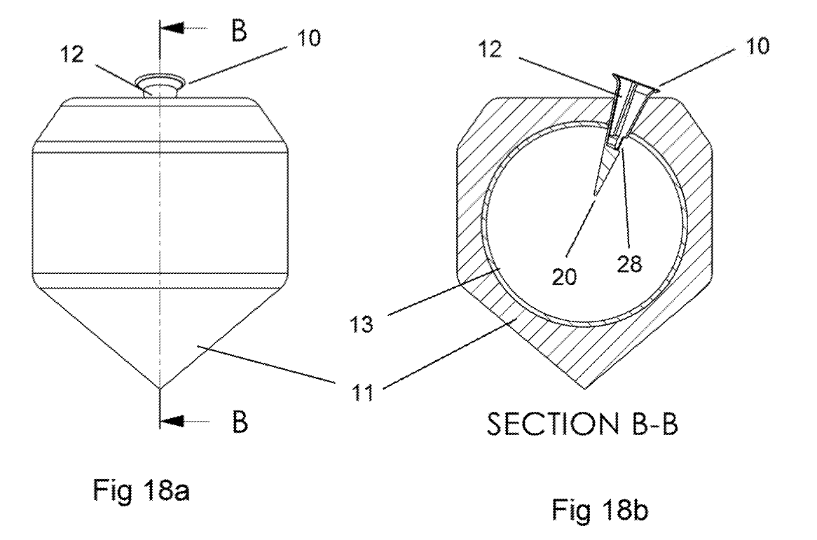

FIGS. 15 to 18 show a third embodiment of a coconut tap 10 in accordance with the present invention. The coconut tap 10 of FIGS. 15 to 18 is similar to the second embodiment and like reference numerals are used to denote like parts. The coconut tap 10 is similar in shape to the second embodiment but does not incorporate the helical thread 36 or handles 38. The body 12 is therefore pushed through the inner shell 13 as described in the first embodiment.

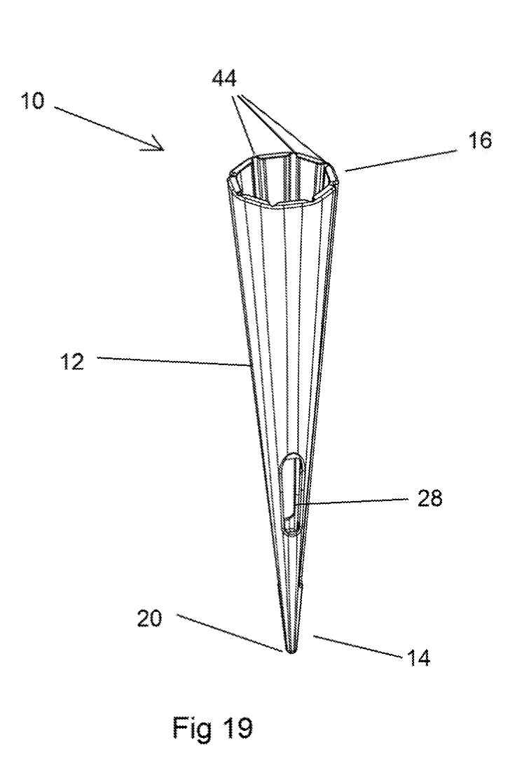

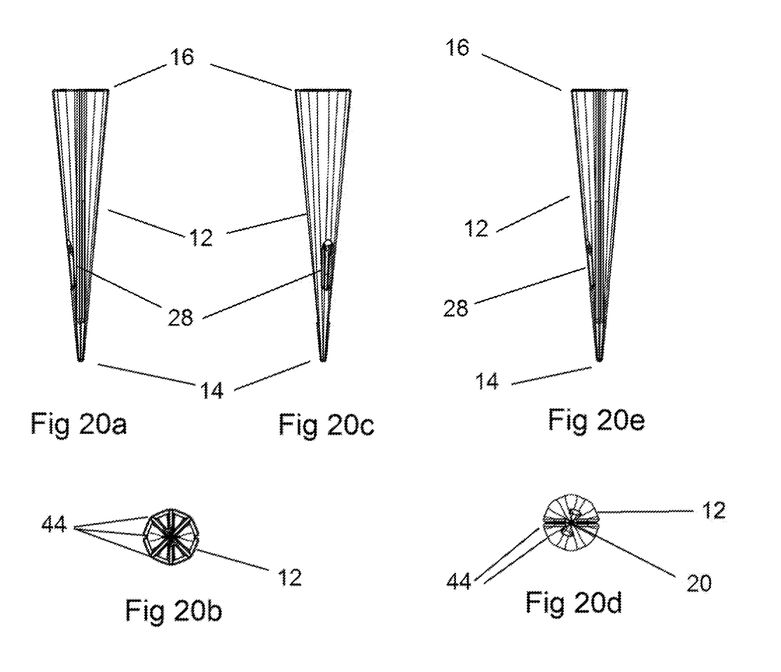

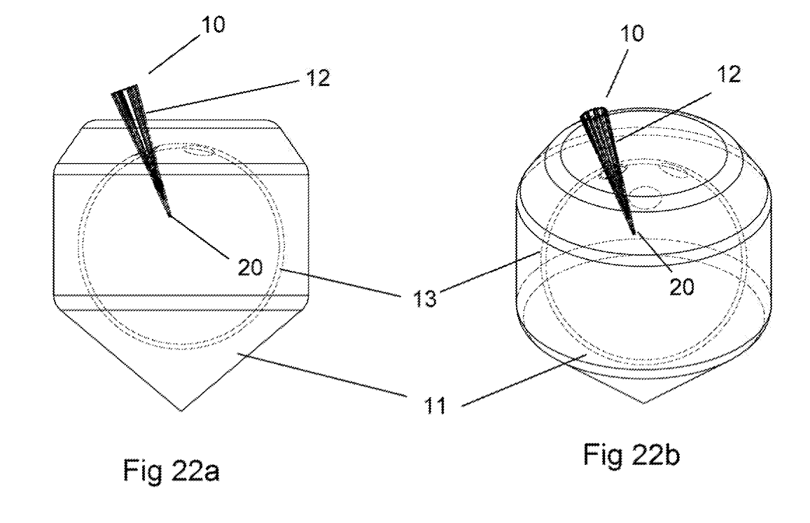

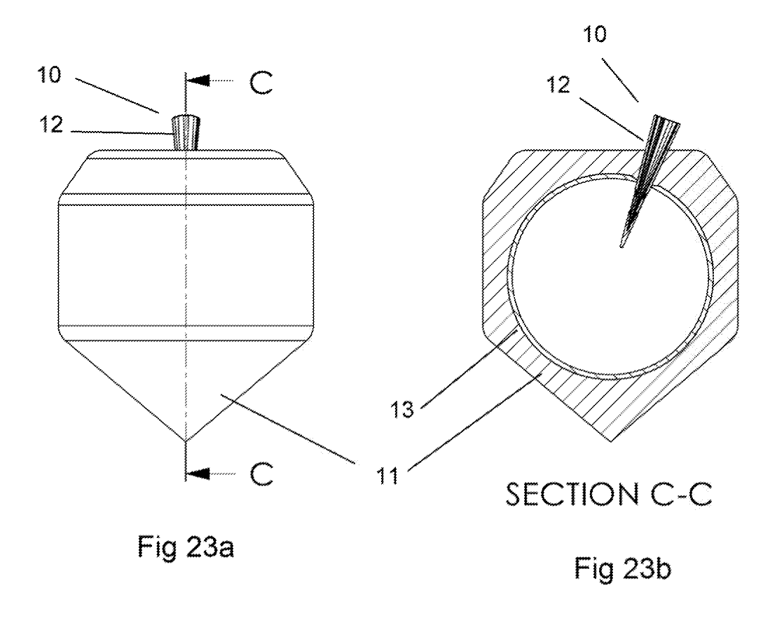

FIGS. 19 to 23 show a fourth embodiment of a coconut tap 10 in accordance with the present invention. The coconut tap 10 of FIGS. 19 to 23 is similar to the third embodiment and like reference numerals are used to denote like parts.

The coconut tap 10 also comprises a body 12 having a closed first end 14 and does not therefore utilise the separate pin 22. The body 12 is conical in shape and generally circular in cross section. The body 12 tapers inwardly from the second end 16 to the first end 14.

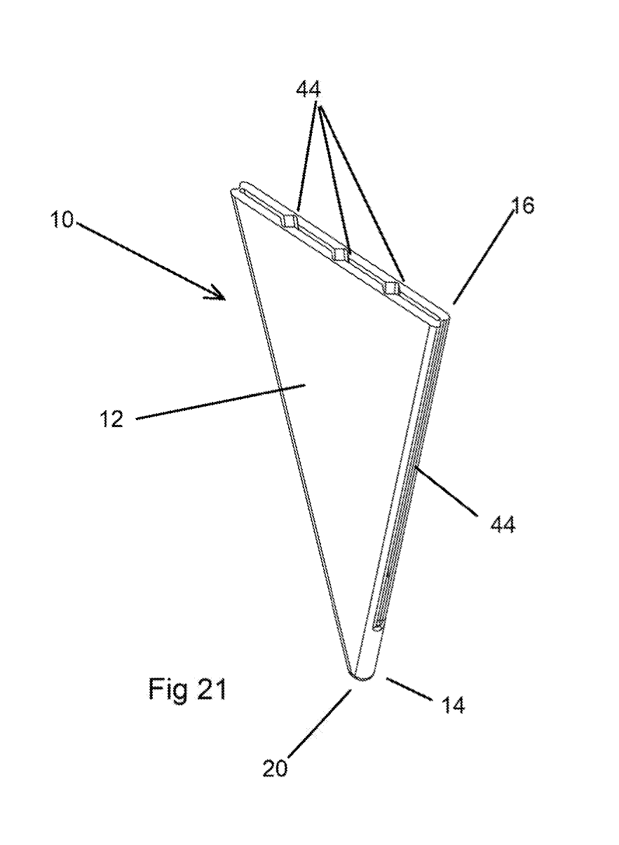

The body 12 includes a plurality of grooves 44 extending from the second end 16 to the first end 14. The body 12 may bend about the grooves 44 such that the body 12 may be collapsed from the tubular configuration to a flattened configuration (as shown in FIG. 21). The coconut tap 10 may therefore be provided in the flattened configuration at the point of sale. For example, the coconut tap 10 may be packed in with the coconut packaging. The coconut tap 10 may then be expanded when the coconut 11 is unpacked and used as described previously.

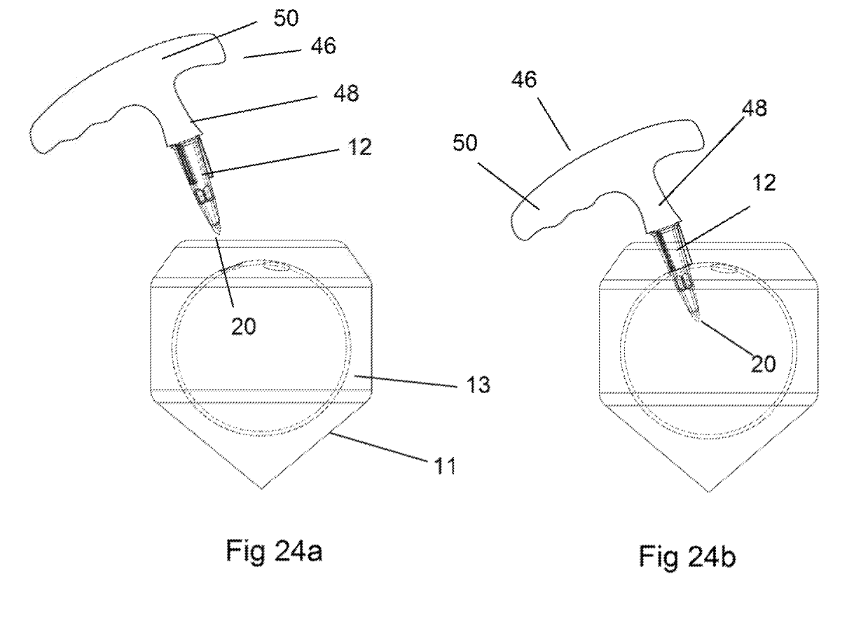

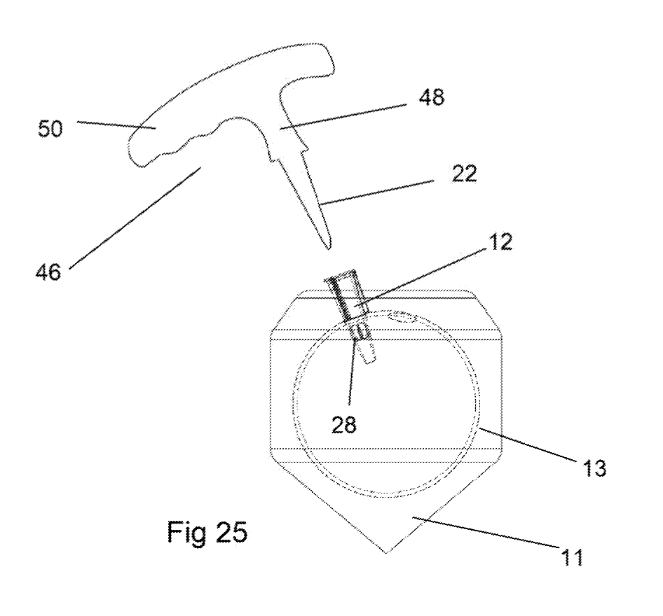

FIGS. 24 and 25 show a fifth embodiment of a coconut tap 10 in accordance with the present invention. The coconut tap 10 of FIGS. 24 and 25 is similar to the first embodiment and like reference numerals are used to denote like parts.

The coconut tap 10 includes the same arrangement as that of FIGS. 1 to 10, however the pin 22 is provided with an applicator 46 connected to the second end thereof. The applicator 46 comprises a T-shaped handle having a shaft 48 connected to the second end of the pin 22 and a handle portion 50 extending transversely to the shaft at an end remote from the pin 22. As can be seen in FIGS. 24 and 25, the coconut tap 10 works in the same manner as the first embodiment but the applicator 46 allows the coconut tap 10 to be gripped by the handle portion 50 for insertion of the nose portion 20 into the coconut 11. The coconut tap 10 is expected to comprise a disposable item constructed from a suitable plastic. The applicator 46 however may comprise a re-usable device formed, for example, from a metallic material such as stainless steel.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A coconut tap comprising:
a tubular body having a tapered portion adjacent a first end;
a pin received an open second end of the body such that a pointed first end of the pin protrudes through an opening in the first end of the body;
one or more apertures in a side wall of the body adjacent the first end thereof;
wherein when the pin is received in the body, the first end of the body may be inserted through the inner shell of a coconut at the site of an eye of the coconut so that the apertures are located inside the inner shell of the coconut such that water from within the coconut may enter the body when the pin is removed and exit the body via the open second end.

26. The coconut tap in accordance with claim 25, wherein the pin comprises an elongate shaft including a head adjacent the second end thereof such that the head engages with the second end of the body.

27. The coconut tap in accordance with claim 26, wherein the body comprises a tube being circular in transverse cross section.

28. The coconut tap in accordance with claim 27, wherein the tapered portion tapers inwardly such that the diameter of the tube remains constant or decreases from the second end to the first end.

29. The coconut tap in accordance with claim 28, wherein the tube tapers inwardly from the second end to the first end.

30. The coconut tap in accordance with claim 29, wherein the shaft of the pin includes an inwardly taper corresponding with the taper of the tube.

31. The coconut tap in accordance with claim 30, wherein the pointed first end of the shaft of the pin protruding beyond the opening in the tube includes a solid outer surface.

32. The coconut tap in accordance with claim 31, wherein the shaft includes a solid outer surface such that the outer surface of the shaft engages against an inner surface of the tube along the length thereof and blocks the apertures in the tube.

33. The coconut tap in accordance with claim 32, wherein the shaft comprises an unbroken frustoconical outer wall.

34. The coconut tap in accordance with claim 25, wherein the body is provided also with ribs on the outer surface thereof.

35. The coconut tap in accordance with claim 34, wherein the ribs comprise elongate planar protrusions extending longitudinally along the body from the second end to a location between the second end and the first end.

36. The coconut tap in accordance with claim 35, wherein the ribs extend from the second end of the tube to a location adjacent the apertures such that ends thereof engage with the inner shell when the apertures are located inside the inner shell.

37. The coconut tap in accordance with claim 36, wherein the head of the pin include protrusions on an underside located adjacent the ends of the ribs.

38. The coconut tap in accordance with claim 25, wherein the body is provided with a pair of apertures adjacent the first end.

39. The coconut tap in accordance with claim 38, wherein the apertures comprise elongate apertures aligned along the length of the body.

40. The coconut tap in accordance with claim 25, wherein the pin is provided with an applicator connected to the second end thereof.

41. The coconut tap in accordance with claim 40, wherein the applicator comprises a T-shaped handle having a shaft connected to the second end of the pin and a handle portion extending transversely to the shaft at an end remote from the pin.

42. A coconut tap comprising:
a tubular body having first and second ends, the body having a tapered portion adjacent the first end;
one or more apertures in a side wall of the body adjacent the first end thereof;
wherein the first end of the body may be inserted through the shell of a coconut at the site of an eye of the coconut such that the apertures are located inside the inner shell of the coconut such that water from within the coconut may enter the body via the apertures and exit the body via the open second end

43. The coconut tap in accordance with claim 42, wherein the body has a closed first end comprising the nose portion of the coconut tap.

44. The coconut tap in accordance with claim 43, wherein an outer surface of the body is provided with a helical thread and the first end of the body is provided with a pair of handles extending outwardly from the body on opposite sides thereof such that the body may be rotated to draw the body through the coconut.

45. The coconut tap in accordance with claim 43, wherein the body is movable from a tubular configuration to a flattened configuration for packaging.

46. The coconut tap in accordance with claim 45, wherein the body includes a plurality of grooves extending from the second end to the first end such that the body may bend about the grooves to be collapsed from the tubular configuration to the flattened configuration.

47. The coconut tap in accordance with claim 42, wherein the body is provided with an air channel comprising a conduit extending from the second end of the body to a location adjacent the apertures to allow air to be drawn into the interior of the coconut as the water flows outwardly through the body.

48. A method of tapping a coconut comprising the steps:
locating an eye of the coconut;
inserting a tapered first end of a tubular body through an inner shell of the coconut at the position of the eye; and
draining water from within the coconut
